(19) United States
(12) Patent Application Publication
(10) Pub. No.: US 2013/0060471 A1
(43) Pub. Date: Mar. 7, 2013

(54) Estimating energy savings and carbon offsets for buildings in real-time

(71) Applicants: Mark A. Aschheim, Santa Clara, CA (US); Jorge E. Gonzales Cruz, Baldwin, NY (US); Edwin P. Maurer, Santa Clara, CA (US); Sergio Escobar-Vargas, Santa Clara, CA (US)

(72) Inventors: Mark A. Aschheim, Santa Clara, CA (US); Jorge E. Gonzales Cruz, Baldwin, NY (US); Edwin P. Maurer, Santa Clara, CA (US); Sergio Escobar-Vargas, Santa Clara, CA (US)

(21) Appl. No.: 13/410,805

(22) Filed: Mar. 2, 2012

Related U.S. Application Data
(63) Continuation-in-part of application No. 13/185,922, filed on Jul. 19, 2011, now abandoned.
(60) Provisional application No. 61/399,947, filed on Jul. 19, 2010.

(51) Int. Cl. G01K 17/00; G01W 1/00; G06F 15/00

(52) U.S. Cl. 702/3; 702/136

(57) ABSTRACT

Real-time monitoring of an energy characteristic of a building such as an energy performance of the building or a carbon offset of the building is performed by first computing a heat transfer coefficient of the building from nighttime steady-state thermal load data of the building and from nighttime steady-state indoor and outdoor temperature data of the building. A thermal inertia of the building is then computed from nighttime transient indoor temperature data of the building and nighttime transient thermal load data of the building. During daytime, a solar radiation gain coefficient is computed from daytime thermal load data, daytime indoor and outdoor temperature data, incident solar radiation data, and the heat transfer coefficient. The energy characteristic of the building is then estimated in real time from the heat transfer coefficient, the thermal inertia, and the solar radiation gain coefficient.

### CROSS-REFERENCE TO RELATED APPLICATIONS

This application is a continuation-in-part of U.S. patent application Ser. No. 13/185,922 filed Jul. 19, 2011, which claims priority from U.S. Provisional Patent Application 61/399,947 filed Jul. 19, 2010, both of which are incorporated herein by reference.

### FIELD OF THE INVENTION

The present invention relates to systems and methods for real-time determination of energy characteristics and thermal characteristics of buildings.

### BACKGROUND OF THE INVENTION

Methods for evaluation of the energy performance of residential buildings are of importance for many reasons including the need to reduce emissions of greenhouse gases (GHGs). Energy used by heating, ventilation, and air-conditioning (HVAC) systems in buildings also represents a significant operating cost of buildings. To reduce such energy consumption, energy inefficiencies can be identified and measures taken to make a building and its HVAC system more energy efficient. Improved energy efficiencies and reduction in energy consumption can be obtained in many ways, including energy-efficient building design or energy retrofits which encompass a wide range of improvements whose cost/benefit values can vary considerably. For example, oversizing or undersizing of HVAC systems can result in inefficiencies. It is currently difficult, however, to accurately estimate the heating and cooling demands for a particular building and properly size an HVAC system.

Estimation of building energy performance is key to optimizing systems and quantifying energy efficiencies. Currently, energy performance of buildings may be estimated using complex commercial energy simulation tools. Various simplified procedures are often used to size residential HVAC equipment, but these require the assistance of professional technicians familiar with proper procedures for performing sizing calculations.

Cho and Haberl [Cho S. and Haberl J., Integrating Solar Thermal and Photovoltaic System in Whole Building Energy Simulation, in SimBuild 2010 4th National Conference of IBPSA-USA] proposed a methodology for the integration of solar thermal and PV systems with the DOE-2.1e simulation program where the UA value of residential buildings may be estimated. This methodology also estimates energy savings. UA is an important parameter in determining the building efficiency and it is a function not only of the building geometry and materials but also on the air moisture content. The building load estimates in Cho and Haberl, however, are based on long-term climate records, which leads to large error (oversizing or undersizing) in the sizing of HVAC systems. Cho and Haberl is also limited to heating loads.

Nassiopoulos and Bourquin [Nassiopoulos A. and Bourquin F., Real-Time Monitoring of Building Energy Behaviour: a Conceptual Framework, in Fourth National Conference of IBPSA-USA] developed a conceptual framework to estimate the energy performance in real-time and using a minimum number of sensors. However, it does not estimate energy and/or carbon savings, and does not determine the thermal properties of the building. Further, their methodology has not been validated.

Noveda Technologies, Inc., provides a system that monitors energy performance of buildings in real-time based on an array of segregated sensors. This is the conventional industry approach where a large number of sensors are used to estimate building performance and savings. This approach, however, is not intended to extract a building's instrinsic energy performance parameters and requires large capital and time investments to be implemented, particularly in residential and light commercial buildings.

Bogolea et al. (US Patent Application Pub. No. 20080224892) also proposes a method and device for real-time measurement of energy performance using sensors and wireless communication. This device requires sensors at every energy consumer component, and does not report against benchmarks, does not report carbon offsets, and does not suggest how to size HVAC systems for improved energy and cost savings and quantification of carbon offsets.

U.S. Pat. No. 7,457,758 to Zimmerman and U.S. Pat. No. 7,529,705 to Bartels et al. refer to the trading of carbon offsets once measured. These methods provide for the post-processing of the carbon offsets obtained from buildings, but do not produce the carbon offsets themselves.

In view of the above, no known system or method provides a way to extract the building envelope characteristic of a building, reports on energy savings based on benchmarks, and reports total carbon offsets on real-time basis. What is needed is a far more simplified and reliable method to estimate energy efficiencies and energy demands in residential buildings.

There is a need for simplified methods to quantify real-time energy efficiencies of building facilities and their relationship to carbon offsets. Such methods are desired to enable trustworthy quantifiable carbon credit offsets claims and to motivate consumers to participate in a possible cap-and-trade market of CO₂.

### SUMMARY OF THE INVENTION

In one aspect, the present invention provides a method based on energy balance to determine energy performance of solar residential buildings and the thermal performance of residential buildings. The building characteristic parameters such as the overall heat transfer coefficient, the thermal inertia, and the radiation factors are determined from nighttime and daytime readings of indoor and outdoor temperatures, solar radiation, and total energy usage of the building. The model is based on the insight that the overall heat transfer coefficient (thermal response) UA of the building is linear with the difference in indoor and outdoor temperatures. Radiation factors for the building can be represented as nonlinear functions of time.

In one aspect, the invention provides a method for real-time monitoring of energy performance of a building. The method includes the following steps: during nighttime steady-state conditions, recording nighttime steady-state thermal load data of the building and recording steady-state indoor and outdoor temperature data of the building; computing a heat transfer coefficient of the building from the nighttime steady-state thermal load data and from the steady-state indoor and outdoor temperature data; during nighttime transient conditions, recording transient indoor temperature data of the building and nighttime transient thermal load data of the building; computing a thermal inertia of the building from the transient indoor temperature data and the nighttime transient thermal load data of the building; during daytime, recording daytime thermal load data of the building, daytime indoor and outdoor temperature data of the building, and incident solar radiation data; computing a solar radiation gain coefficient from the daytime thermal load data, the daytime indoor and outdoor temperature data, the incident solar radiation data, and the heat transfer coefficient; estimating in real-time (a) an energy performance of the building by combining estimated energy used for HVAC loads and total energy consumed by the building at the meter or (b) a carbon offset of the building by comparing total energy performance with that associated with the use of performance requirements or prescribed building materials and appliances as specified in state and/or national standards.

According to another aspect, a method for determining thermal characteristics of a building is provided. The method includes the following steps: during nighttime steady-state conditions, recording nighttime steady-state thermal load data of the building and recording steady-state indoor and outdoor temperature data of the building; computing the heat transfer coefficient of the building from the nighttime steady-state thermal load data and from the steady-state indoor and outdoor temperature data; determining from the heat transfer coefficient the thermal characteristics of the building, wherein the thermal characteristics comprise a) the overall heat transfer coefficient of the building and thermal mass which is used to establish a building heating and cooling requirement, b) a building heating and cooling requirement c) a building energy retrofit need estimate, d) a building energy performance assurance value, or any combination of a), b), c), and d).

In the methods above, the building may be of any type, e.g., residential or commercial. The recording of temperature can involve collecting the data from any source, e.g., from a sensor directly connected to the system or communicated from an external source such as a weather service. Similarly, the incident solar radiation data can be collected from any source, e.g., from a sensor directly connected to the system or communicated from an external source such as a weather service.

The real-time energy performance, carbon offset, or thermal characteristic of the building may be automatically displayed, recorded, communicated elsewhere, or used in various ways as described in more detail herein.

The model may be implemented as a tool to monitor real-time energy performance of a building; it also can be useful for sustainability rating systems based on demonstrated performance rather than intended performance. Other applications include measurement of carbon emissions and offsets from residential buildings and sizing of HVAC systems. The techniques can also be applied to the exchange of energy information between consumers and energy providers such as utilities, and to provide objective rating methods for owners of existing buildings and for use in real estate markets. The techniques of the present invention are accurate, easy to implement, and cost effective. The method provides a quantifiable and real-time evaluation of thermal performance and energy efficiencies in a building.

The thermal load estimate is based on the degree days (DD) methodology where the approximate energy performance of any facility is estimated based on the temperature difference for reference indoor and outdoor conditions. This follows the general assumption that each facility will have a characteristic overall energy loss/gain factor. This is in general true, and the loss/gain factor is commonly referred to as the overall heat transfer coefficient, UA, of the space. Under steady state conditions, thermal load of the facility generally will equal the product of UA and DD. According to the present invention, the UA of any facility may be determined from real-time energy balances over time. The method, which may be implemented as a device or system) may compute the UA information of any facility by monitoring the total energy of the system and linearly correlating it with the outdoor-indoor temperature difference. The linear response corresponds to the thermal load, particularly during night times. Additional corrections may be made to account for solar radiation (during daytime), humidity, and wind. These variables can be measured and the corresponding thermal loads correlated with ambient temperature and building area. Monitoring this energy balance may be performed by instruments to measure indoor and outdoor temperature and humidity, solar radiation, wind, and total energy of the facility. Thus the device and method disclosed herein records data such as indoor and outdoor temperature and humidity, total energy consumption, solar radiation, and wind. This information is stored, and when a suitable amount of information is available, the linear response during night-time is extracted as function of indoor-outdoor temperature difference. This linear response is associated with the thermal performance of the building envelope (UA*DT). Adjustments may be made to account for relative humidity and wind. The method also allows measurements of the transient element of the building, an indication of the thermal capacitance (or thermal mass/inertia) of the building, which governs its response to temperature changes over time. The building envelope energy component equals the sum of the steady and transient thermal response. The net difference between this building envelope energy component and the measured total energy is attributed to appliances and lighting. This information can be further segregated if sensors are available at the appliance/lighting levels.

The real time energy efficiency is estimated using benchmarks for energy consumption elements within the building. The thermal load is compared with equivalent benchmarks for building envelope according to state/federal regulations. The energy performance for lighting and appliances is equally compared with established benchmarks as a single group or segregated according to sensors/information available. The resulting addition are the net energy savings that a home can claim over established minimum energy efficiency standards. These savings may be converted into carbon offsets by using the proper conversions of kWh to Tons of CO₂ required at a power plant operating. A typical measure of power plant operating performance is 33% efficiency (approximately 3 lb CO₂/kWh). The final information can be stored for further download or broadcasted to authorized individuals or group users via LAN or wireless.

### BRIEF DESCRIPTION OF THE DRAWINGS

FIG. 1 is a flow diagram outlining a method of estimating in real time an energy characteristic of a building according to an embodiment of the invention.

FIG. 2 is a flow diagram outlining a method of determining a thermal characteristic of a building according to an embodiment of the invention.

FIG. 3 is an isometric view of a building with sensors for making measurements according to embodiments of the present invention.

FIG. 4A is a graph of indoor temperature vs. time, illustrating the temperature response during nighttime and a boundary between a transient phase and a steady-state phase, according to embodiments of the present invention.

FIG. 4B is a graph of thermal load vs. indoor-outdoor temperature difference, illustrating the calculation of a building heat transfer coefficient, according to embodiments of the present invention.

FIG. 5 is a graph of F(t)A vs. time for a building, illustrating the calculation of an overall solar radiation gain coefficient of a building, according to embodiments of the present invention.

FIG. 6 is an isometric view of a building with sensors for making measurements, a smart meter, and a carbon meter, according to embodiments of the present invention.

FIG. 7 is a flow diagram outlining a method of estimating in real time an energy characteristic of a building according to an embodiment of the invention.

FIG. 8 is a flow diagram outlining a method of determining a thermal characteristic (UA, F(t)A, and mcₚ) of a building according to an embodiment of the invention, where the parameter ∈ is a tolerance value, tₘᵢₙ a minimum threshold time for which the steady-state condition lasts, and 0.6 is the total temperature allowed oscillation from the beginning to the end of the defined steady-state interval

### DETAILED DESCRIPTION

In the description that follows, the following nomenclature will be used.

A Building inside/outside heat transfer surface area (m²)

A_{c} Conduit cross sectional area (m²)

E Efficiency

EA Energy rate consumption of appliances (W)

Ėtₒₜₕₑᵣ Energy rate from other unaccounted energy sources (W)

F(t) Overall solar radiation gain coefficient (radiation response) of the building

I instantaneous incident radiation on the building (W/m²)

\dot{Q} Energy rate (W)

\dot{Q}_{TL} building thermal load

T Temperature (° C.)

ΔT temperature difference between the building indoors and outdoors

U Overall heat transfer coefficient (W/m²K)

V Velocity (m/s)

cₚ Building air specific heat at constant pressure (J/kgK)

t Time (s)

$$\frac{d T}{d t}$$

rate of change of the building air temperature (T) change with time (t)

m building air mass

\dot{m} Mass flow rate (kg/s)

mcₚ thermal capacitance (or thermal mass/inertia) of the building

UA Thermal resistance, thermal response, building heat transfer coefficient

Greek Ssymbols

Δ Difference

ε Tolerance

ρ Density (kg/m³)

Subscript

I Radiation

TL Thermal load

UA Thermal resistance, thermal response, building heat transfer coefficient

building Building

flow Flow

in Inward

model Model

out Outward

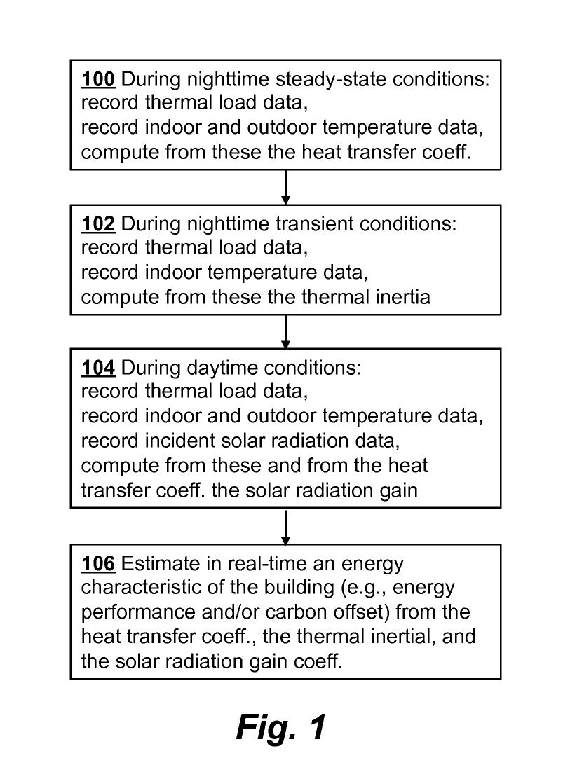

FIG. 1 is a flowchart outlining a method for real-time monitoring of energy performance of a building according to one embodiment of the present invention. The method includes recording data for a building during nighttime and daytime conditions. FIG. 3 shows such a building 300. Temperature sensors 302 and 304 are used to make temperature measurements outside and inside, respectively. Solar radiation sensor 306 is used to make measurements of incident solar radiation during daytime. Carbon meter device 306 is connected to sensors 302, 304, 306. In addition, meter device 306 may be connected to an HVAC system in the building (not shown) as well as to the internet.

Returning to FIG. 1, step 100 includes recording data during nighttime steady-state conditions. Specifically, nighttime steady-state thermal load data of the building is recorded and steady-state indoor and outdoor temperature data of the building is recorded. A heat transfer coefficient of the building is computed from this recorded nighttime data, as will be described in more detail below.

In the context of this description, the term “steady-state” is defined to mean a state in which the building air temperature changes by no more than 0.5° C. over a period of at least 10 minutes. The term “transient” is defined to mean a state that is not steady-state.

Step 102 includes recording data during nighttime transient conditions. Specifically, nighttime transient indoor temperature data of the building is recorded and nighttime transient thermal load data of the building is recorded. A thermal inertia of the building is computed from this recorded data, as will be described in more detail below.

Step 104 includes recording data during daytime conditions. Specifically, daytime thermal load data of the building are recorded, daytime indoor and outdoor temperature data of the building are recorded, and incident solar radiation data are recorded. A solar radiation gain coefficient is computed from this recorded data in combination with the heat transfer coefficient computed in step 100, as will be described in more detail below.

Step 106 includes estimating in real-time an energy characteristic of the building, which may include, for example, (a) an energy performance of the building, or (b) a carbon offset of the building. This energy characteristic is computed from the heat transfer coefficient, the thermal inertia, and the solar radiation gain coefficient, as will be described in more detail below.

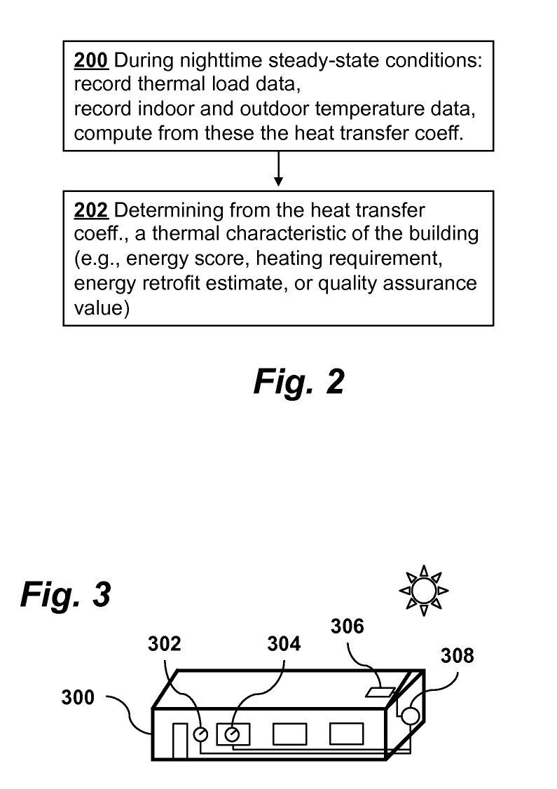

FIG. 2 is a flow diagram outlining a method of determining a thermal characteristic of a building according to another embodiment of the invention. In step 200, data is recorded during nighttime steady-state conditions. Specifically, nighttime steady-state thermal load data of the building is recorded and steady-state indoor and outdoor temperature data of the building is recorded. A heat transfer coefficient of the building is computed from this recorded data, as will be described in more detail below.

In step 202, a thermal characteristic of the building is computed from the heat transfer coefficient computed in step 200, as will be described in more detail below. The thermal characteristics may include, for example, a) a building energy score, b) a building heating requirement, c) a building energy retrofit estimate, d) a building quality assurance value, or any combination of a), b), c), and d).

Having outlined the methods above, the following description will provide further details and alternative embodiments of the techniques.

Techniques of the present invention make use of an innovative model based on an energy balance concept to estimate energy performance of any building. The model makes several assumptions that are expected to be valid or approximately valid for most residential buildings. It assumes a uniform temperature inside the residential building; it also neglects infiltration rate (e.g., windows or doors open) and possible heat sources (people). These assumptions, however, may be relaxed in some embodiments.

One practical application of the techniques of the present invention is to provide a simplified energy model concept that is useful to establish energy performance for a range of applications in the residential sector. One application is called a carbon meter to emphasize the application for quantifying carbon offsets to reduce GHG. The techniques can estimate energy parameters that characterize the building performance (e.g., overall heat transfer coefficient U, thermal inertia). The building energy performance is affected by the building thermal response, energy consumption by appliances, lighting, and hot water system. The building thermal response is the most unpredictable of the components of most ordinary residential buildings.

Assuming the building indoor temperature is uniform, the building thermal response can be estimated from energy balance considering the envelope as the system. The thermal load \dot{Q}_{TL} from the building is equal to the sum of four terms: 1) a transient response term involving the rate of change of temperature

$$\frac{d T}{d t}$$

and the thermal inertia mcₚ; 2) the net energy exchange due to inside and outside temperature difference ΔT involving the thermal resistance (overall heat transfer coefficient) UA of the building; 3) a radiation term involving the net solar radiation gain coefficient F(t) and incident radiation I; and 4) other unaccounted energy losses Ėₒₜₕₑᵣ. This may be expressed as follows:

$${\dot{Q}}_{TL} = {mc}_{p} \frac{d T}{d t} + UA Δ T + F ( t ) AI + {\dot{E}}_{other} \qquad Eq . 1$$

where \dot{Q}_{TL} is the building thermal load (W), m is the building air mass (kg), cₚ the air specific heat at constant pressure (J/kgK), mcₚ is the thermal capacitance (or thermal mass) of the building,

$$\frac{d T}{d t}$$

the rate of the building air temperature (T) change with time (t), U is the overall heat transfer coefficient of the building, A the building surface area where heat transfer occurs between the inside and the outside, ΔT the temperature difference between the building indoors and outdoors, F(t) is the radiation response of the building or the overall radiation gain coefficient, I is the instantaneous incident radiation on the building (W/m²), and Ėₒₜₕₑᵣ refers to unaccounted energy streams.

For the purposes of this description, Eq. 1 above is based on the following assumptions: the whole residential building is considered to be at uniform temperature, the outdoor temperature is assumed uniform, humidity variations are not considered significant, impacts of wind speed variations are not considered significant (i.e., convective heat transfer coefficient and wind-driven infiltration changes are small), the overall heat transfer coefficient incorporates both convective and radiative energy exchanges between the building and the ambient, effects of cloud cover are included in the F(t) parameter, infiltration is neglected, and the presence of people (warming and change in latent heat) is considered negligible. Some of these effects may have significance under conditions different from those considered valid for the present model. However, those skilled in the art will recognize that the model may be generalized by relaxing these assumptions appropriately in light of the principles of the present invention.

Several of the parameters of Eq. 1 can be estimated for each building using data recorded from real-time sensors. For example, during nighttime when I=0, Eq. 1 simplifies to (assuming Ėₒₜₕₑᵣ is negligible):

$${\dot{Q}}_{TL} = ( {mc}_{p} ) \frac{d T}{d t} + ( UA ) Δ T \qquad Eq . 2$$

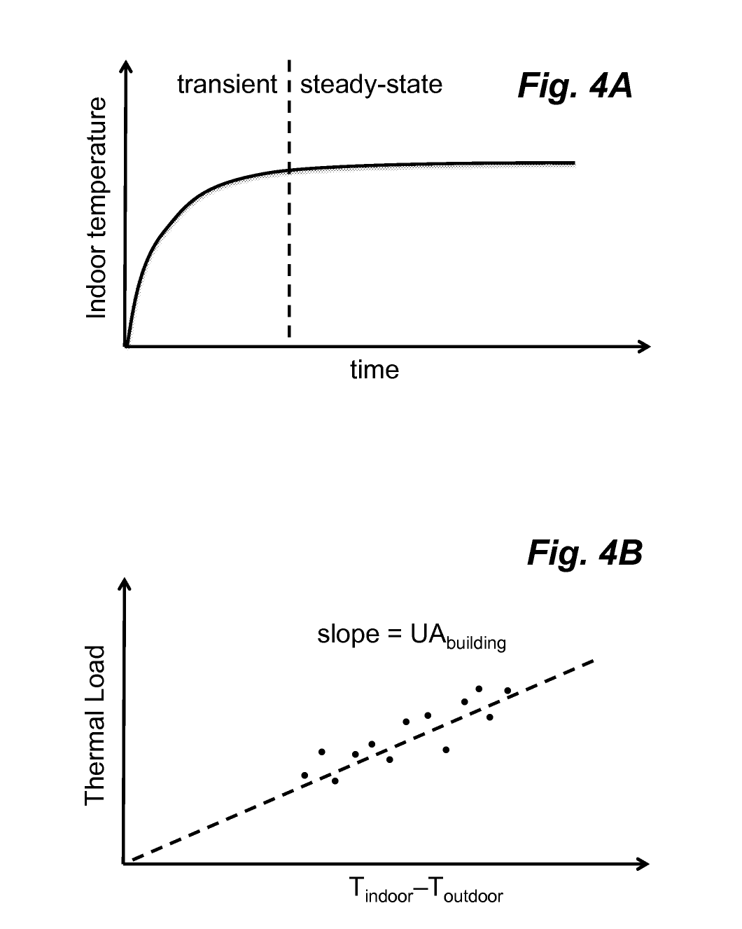

During nighttime conditions, a reading of the total energy from the building and/or the HVAC system (thermal load \dot{Q}_{TL}) and its correlation with measurements of indoor and outdoor temperatures may be used to determine both the thermal capacitance/inertia mcₚ and overall heat transfer coefficient U for the given building. This is done by separately considering the transient and steady-state conditions at night. FIG. 4A, for example, shows a graph of a typical temperature response from a building during a nighttime heating period. After an initial transient portion, the indoor building temperature reaches a steady-state condition. In this region, the temperature remains constant, so the transient term involving

$$\frac{d T}{d t}$$

vanishes. During such steady-state conditions, Eq. 2 reduces to a direct relation between the thermal load \dot{Q}_{TL} and the UA value of the building.

\dot{Q}_{TL}=UAΔT Eq. 3

Thus, during nighttime steady-state conditions, a linear correlation of building energy consumption with temperature difference can be used to determine the UA value for each building, as shown in FIG. 4B. The temperature difference ΔT between indoors and outdoors may be measured with temperature sensors. The heat supplied to the building can be determined in several ways. For electrical systems Eq. 3 will apply by directly measuring total energy from the building energy meter. For gas systems (air or radiant flooring), from energy balance at the heating/cooling coil by knowing the temperature, mass flow rate, specific heat, and the moisture content change as given in Eq. 4:

\dot{Q}_{TL}=\dot{m}cₚ(Tₒᵤₜ−Tᵢₙ)_{flow}+\dot{m}_{w}h_{fg} Eq. 4

For heating conditions, it is assumed the total energy is sensible heating, and the temperature difference (Tₒᵤₜ-Tᵢₙ)_{flow} is measured with thermocouples at input and output of the heating coil and the mass flow rate is estimated from the conduit supplying flow into the house and using the relation \dot{m}=ρVA_{c} where ρ is the flow density (kg/m³), V the velocity (m/s), and A_{c} the conduit cross sectional area (m²). Combining Eq. 3 and Eq. 4 allows the building UA value to be estimated:

\dot{m}cₚ(Tₒᵤₜ−Tᵢₙ)_{flow}=UAΔT_{building} Eq. 5

where ΔT_{building}=(T_{inside}−T_{outside})_{building}. Therefore the only unknown is UA, and this factor is independent of time since it is function of the building geometry, materials, and workmanship. (The potential variation of UA with temperature is considered negligible). The energy balance can be applied at the heating coil for air systems or at the water loop for gas heating water systems. For electrical systems, Eq. 3 will apply.

The UA value may be affected by changes in the infiltration rate. However, since the HVAC is set for a constant flow of fresh air and any uncontrolled infiltration through the building gaps will also be constant for the most part, thus the empirically determined UA value accounts for infiltration and should correlate to the temperature difference (T_{inside}−T_{outside}). For winter times the energy consumption due to latent loads is very small and the method should hold strong. For summer times (cooling mode) the infiltration analysis above described applies, however, latent loads may be larger and this load will need to be incorporated as \dot{m}_{w}h_{fg} thus there will be a need to incorporate this latent load term. Including these terms will capture the effect of changes on humidity, thus the need to monitor humidity indoors and outdoors.

The transient nighttime response can be used to determine the overall thermal inertia/capacitance mc, of the building, which is constant. Eq. 2 holds at night, and the UA value has already been estimated. Eq. 4 can be used to estimate the thermal load. Thus,

$$\dot{m} {{c}_{p} ( {T}_{out} - {T}_{in} )}_{flow} - ( UA ) Δ T = ( {mc}_{p} ) \frac{d T}{d t} \qquad Eq . 6$$

The building temperature rate of change

$$\frac{d T}{d t}$$

is determined from direct measurements of the indoor air temperature history. The mass flow rate is calculated using the steady state continuity equation for a conduit, \dot{m}=ρVA_{c} for gas heating systems. For electrical heating systems, Eq. 2 will apply.

After the UA and mcₚ values have been determined from nighttime data, daytime parameters, such as the solar radiation gain coefficient F(t), can be computed by correlating thermal load \dot{Q}_{TL} with measurements of indoor/outdoor temperatures and incident solar radiation I. Although solar radiation sensors are relatively expensive, incident radiation information can alternatively be obtained from nearby weather stations.

The radiation term F(t)AI is a function of time; this function is estimated based on temperature history measurements of the building at steady state during daytime. Under these circumstances the steady state energy balance equation becomes

\dot{Q}_{TL}=UAΔT_{building}+F(t)AI Eq. 7

Information on the thermal load is obtained directly from the electric consumption of the HVAC system. Incident radiation is known by means of sensors mounted on the building. Rearranging Eq. 6, F(t) is left as a function of the known information:

$$F ( t ) A = \frac{{\dot{Q}}_{TL} - UA Δ T}{I} \qquad Eq . 8$$

The expression

$$\frac{{\dot{Q}}_{TL} - UA Δ {T}_{building}}{I}$$

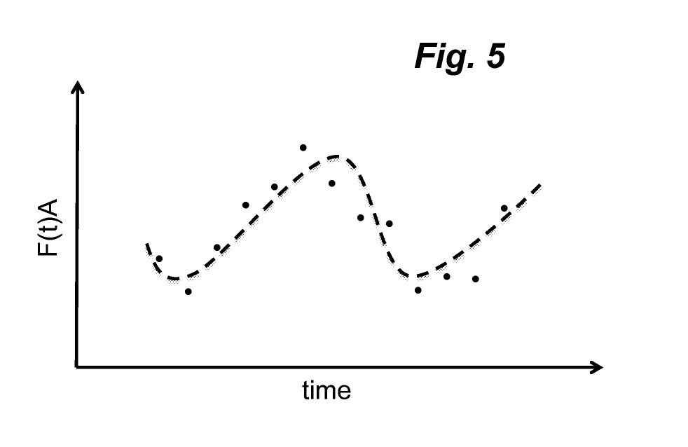

indicates the magnitude of radiation with respect to the difference in the thermal load and the thermal resistance. The fraction has a nonlinear correlation with time. However, a fitting curve of order 4 can be used as a first approach to predict the F(t)A values at a given month of the year, as illustrated in FIG. 5.

As shown in the discussion above, easily measured quantities (indoor/outdoor temperatures and incident radiation over time) can be used with this model to determine essential parameters that characterize the thermal response of the building. Since the model is compared to measured data collected from the building at different conditions to estimate the UA and F(t)A factors, this characterization of building thermal properties can be made independent of occupant behavior.

The model described herein is accurate for cases when the thermal load is dominated by the transient term, building thermal resistance (term involving the UA value), and building radiation solar response (term involving the overall solar radiation gain coefficient). The model may be less accurate in other circumstances, e.g., when Ėₒₜₕₑᵣ is important, which may occur when other factors become dominant such as the infiltration rate (due to doors/windows opening constantly) or if many people are present within or moving in or out of the building.

This method to determine the energy performance of a residential building (i.e., the calculated parameters that characterize the building) is based in part on the insight that there is a linearity of the building thermal resistance to temperature changes during nighttime steady-state conditions. This allows UA to be determined from four temperature measurements (to and from the heating unit, and inside and outside the building) and air velocity in the conduits. F(t) can be determined by temperature and radiation measurements.

The method may be implemented as a system including sensors connected to a computer that records sensor data and performs calculations according to the methods described herein. Some of the data, such as outdoor temperature and incident radiation, may be provided to the computer over communication channels from distant weather stations or other remote sensors rather than from the building. The results of the computations may be stored by the computer, but may also be communicated in real time over a computer network to another computer to provide real time remote access to building performance data.

Variations of the system and method are numerous and include multiple purposes and applications. Some are as follows:

1. Heating system. To implement the method, information on type of space and hot water heating system are collected to discriminate between electric, natural gas, propane, oil, and other sources.

2. Simplified implementations. Reductions in the number and types of on-site sensors may be possible with a relatively small loss of accuracy. For example, the influence of humidity or wind might be neglected, or such data might be obtained via the web or other means from information sources such as the National Weather Service. This will reduce the minimum number of sensors and the complexity of the method.

3. Simplified hardware. Hardware used for computations can be located off-site and possibly in “the cloud,” thereby allowing the hardware devices deployed in the building to be simplified. A very simple form would make use of an internal temperature sensor and communications capability to allow the temperature data to be provided to the off-site location where analysis and processing of data takes place.

4. Forecasting capabilities. The method will enable forecasting energy performance of the building as function of weather conditions as the energy components associated with weather conditions are being characterized. This application is of great value to utilities for demand forecasting and emergency preparation.

5. Solar photovoltaic (PV) and thermal systems. The method can be easily incorporated into existing monitoring systems for solar PV and thermal installations. The carbon off-sets from these applications can be equally incorporated into the method.

6. Guidance for Energy Performance Improvement. The method may be augmented to provide guidance for retrofitting existing structures for improved energy performance. For example, building component contributions to the UA value could be estimated and the relative improvement and costs of various retrofit possibilities or scenarios could be determined. This would allow an owner or third party to determine the most cost effective ways to reduce energy use and/or reduce carbon emissions.

The method has many useful commercialization opportunities including carbon offsets in support of California AB32 Climate Change Bill which opens the carbon credit markets in early 2010; evaluation of property to buy or lease, evaluation of alternative retrofit options, evaluation of carbon consumption and sustainability indices at the individual, household, building, and institutional levels, evaluation of the amount of carbon consumed and/or saved by various mitigation measures (such as thermal and energy capital improvements) and reporting as part of recovering the economic value represented in the carbon credit market.

The method has applications to estimation of CO₂ offsets on a real-time basis based on the energy balance comparing the monitored building to a reference building. For example, relative energy efficiencies can be estimated by benchmarking building performance with established standards, such as Title 24 for the case of California, or the International Residential Code (IRC) which establishes minimum R values for building envelope components, and hence for the entire building. The net difference in energy performance ΔE can be treated as carbon offsets. This concept is formulated in Eq. 9, where EEA refers to energy efficiencies of appliances. In the case of appliances, market standards can be used to determine relative energy performance. An inventory of appliances may be used to determine performance relative to benchmark in the case of appliances.

$$Δ E = Energy Efficiencies = {E}_{building} - {E}_{reference} = Δ [ ( {mC}_{p} ) \frac{d T}{d t} ] + Δ ( UA ) Δ T + Δ ( F ( t ) A ) I + Δ ( EEA ) \qquad Eq . 9$$

The method can be implemented in real-time monitoring devices that contain indoor temperature sensors, and a computer to estimate overall energy consumption of the home. Outdoor parameters may be gathered from nearby weather information available on-line.

For example, data collected from a residential building may be distinguished between the amount of energy consumed and the amount of energy generated by a PV array. From the energy consumption, the consumption of the main components of the residential building may be determined. The energy efficiency of the residential building is then estimated from the energy consumption and the energy production. The relative energy efficiency can be estimated by benchmarking building performance with established standards. The net difference in energy performance can be treated as carbon offsets.

The energy efficiency analysis makes use of the sensors measured total electric energy consumed by the building. The electric energy consumption is classified into three groups: HVAC, appliances, and lights. The HVAC electric consumption is equivalent to the total energy load of the building. The relationship is given by Eq. 10.

$$HVAC = \dot{m} {c}_{p} \frac{d T}{d t} + UA Δ T + FAI \qquad Eq . 10$$

Therefore, the net difference in energy performance considering HVAC, appliances and lights is

ΔE=E_{building}−E_{reference}=Δ(HVAC)+Δ(EEA)+Δ(Lights) Eq. 11

Using Eq. 11 it is possible to compute the net difference in energy performance from electric measurements. The HVAC energy consumption of the building is compared to the one of building with a COP of 3 under the same thermal load.

$${COP}_{model} = \frac{{\dot{Q}}_{TL}}{HVAC} {\vert}_{model} = 3 \qquad Eq . 12$$

Eq. 12 is solved for HVAC model since the thermal load is known. The appliances are compared to the nominal stated energy consumption:

Δ(EEA)=EA_{measured}−EAₙₒₘᵢₙₐₗ Eq. 13

where EA is the energy rate consumption of the appliances. Lights in the monitored building may be assumed as 30% more efficient than the illumination on a regular building. In order to estimate possible carbon offsets Eq. 14 is used

CO_{2offsets}=PV+ΔE Eq. 14

where PV is the energy generated by the building from any solar panels the building may have integrated. ΔE is obtained by the difference in the total energy consumption from the building and the model.

The process and factors used to obtain the CO₂ offsets are as follows.

The energy is converted from kW-h/year to BTU-h/year

E_{BTU}=E_{kW}*3412

The number of gallons of oil 6 (N_Galₒᵢₗ_{_{—}}₆₎ is computed considering the amount of BTUs per gallon (150000) and an efficiency energy conversion factor of 5, thus

N_Galₒᵢₗ_{_{—}}₆=(E_{BTU}/150000)*5

the N_Gal.ₒᵢₗ_{_{—}}₆ is converted into pounds (lb) of CO₂ using the factor 26

lb_{CO2}=(N_Galₒᵢₗ_{_{—}}₆)*26

the total lb_{CO2} is now converted into tons of CO₂

Tons_{CO2}=lb_{CO2}/2000.

The model now can estimate the savings in money by using the equivalent cost of $20/Ton_{CO2} for the carbon offsets (this factor varies with the cost of CO₂ allowances).

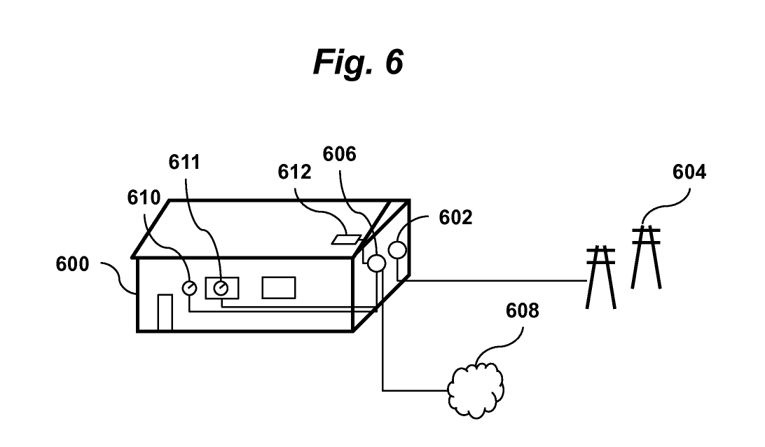

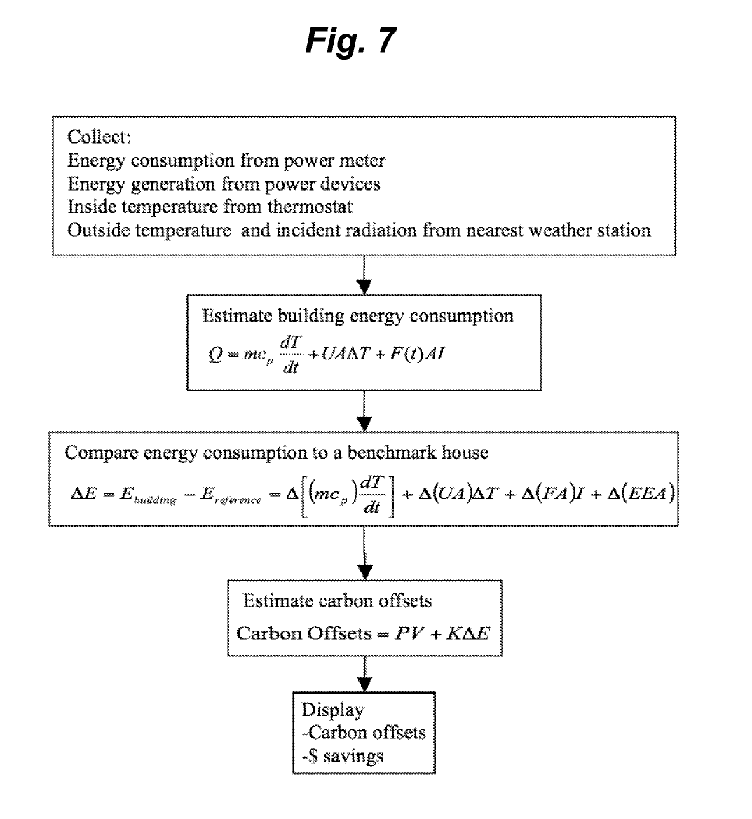

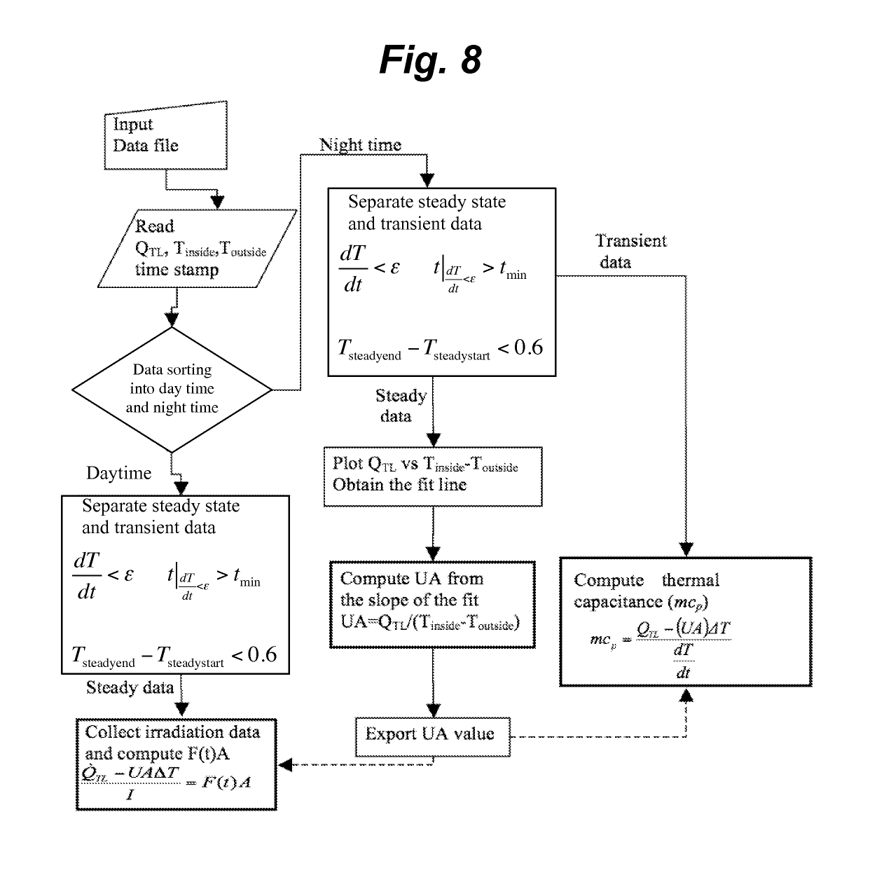

Smart Meters (SMs) provide valuable streams of data containing total energy consumption from buildings to utilities. This information can be used for many purposes, including forecasting demand based on historical records, or identifying specific locations of power outages. The carbon meter (CM) complements SM by segregating further the energy data stream. Accordingly, in some embodiments of the invention an indoor temperature sensor and the methods of the present invention are integrated and combined with existing SMs to provide them with added information pertaining to the HVAC energy and consequently other energy components within the building. Such applications of this technology would help secure the power grid by enabling improved forecasting of energy demands as function of weather events, something difficult to accomplish with total energy demand information alone. A low-cost implementation of CM in SMs may be made by adding a wired or wireless temperature indoor sensor, sending this information to the SM, and programming the CM as described herein. The CM can access the internet to receive weather information from nearby weather stations using the internet access capabilities inherent in the SM. FIG. 6 is a schematic block diagram illustrating such a system. A residential building 600 has installed a smart meter 602 connected to a power grid 604. The smart meter 602 is modified to implement a carbon meter 606. Information from the internet 608 is used by carbon meter 606 together with information from temperature sensors 610, 611 to provide enhanced capabilities, as described above. This enhancement is a significant improvement over the current state of the art which merely reports energy use based on total power. Beyond this, the CM provides detailed information on the HVAC component, which combined with the total energy information, can advise the consumer how exactly the energy is being used (HVAC, appliances, lighting), and how to improve the building envelope to achieve efficiencies.

In another embodiment of the invention, the techniques may be used to calculate a home energy score. The U.S. Department of Energy has a program to allow a home energy score to be determined on the basis of visual inspection by a qualified inspector. The use of measured in-situ thermal properties of the building using the techniques of the present invention provide a more useful and more precise characterization of the thermal properties of the building. This improved accuracy can benefit home owners, sellers, and buyers, as thermal performance relates directly to energy usage and energy costs, in much that same way that a car's MPG rating indicates relative cost of operation. There is also significant marketing value in a high home energy score as people become more conscious of the environmental repercussions of their actions, beyond the mere financial costs and benefits. The energy scoring is determined by the estimated energy performance of the building for both heating and cooling conditions, based on the variables obtained above, similar to EPA energy star rating. The value of the score will be characteristic of each building with units of kWh/yr or Btu/yr (or equivalent) for both heating and cooling.

In another embodiment of the invention, the methods may be used to assist in the appropriate sizing of HVAC systems for new or retrofit buildings. To size HVAC devices, designers conventionally use thermal modeling using commercial software mostly from manufacturers of HVAC equipment, or building energy simulators. These sizing modeling tools, however, often result in over size or under size by more than 50% in most occasions, which could represent a loss of efficiency resulting in more than 25% of the energy bill for the facility. The proposed CM can be used as a stand-alone technique and device for sizing HVAC for specific buildings.

For the case of retrofits, a device according to an embodiment of the invention has components that allow it to interact with the buildings electric and/or gas meters, includes a wireless indoor temperature sensor and access the internet, all packaged with a micro-processor where the information can be stored and processed. The device can be installed in the building for one to several days to determine the specific thermal loads of the building, and consequently the proper sizing of the HVAC by applying the methods described above to determine overall heat transfer coefficient, thermal mass, and radiation function for the building. HVAC design and/or installation firms will now have an added capability to meet specific needs of their clients. The sensor costs will be less than $100 under mass production, and the service can cost less than $500, which is a fraction of the total cost of the HVAC system.

For the case of new buildings, the proposed device above for retrofits can be complemented with a portable HVAC unit to determine proper sizing of the HVAC once the building has been constructed, following a similar protocol as for retrofits.

Energy retrofits are often more cost-effective than solar panels (thermal and photovoltaic) and should be considered, particularly for buildings built prior to codified building energy efficiency requirements. Knowledge of the thermal properties of an existing building, using our technology, can support technologies to identify the best energy retrofit schemes. Knowledge of the actual thermal conductivity (UA) of the building can indicate that additional thermal insulation would be beneficial. Given the actual building conditions (type and amount of glazing, amount of insulation in walls, roof, and floor, presence and effectiveness of weatherstripping, crawlspace conditions, and so on), potential improvements in the building envelope can be evaluated with respect to expected improvement in the UA value, cost, and ancilliary properties (e.g. durability, aesthetics, etc). These potential improvements can be ranked in terms projected improvement in UA value relative to cost. Those improvements with sufficient return on investment can be identified and implemented. For these retrofits, the same approach used for sizing of HVAC equipment will be used—a device will be built containing basic sensors and the algorithms to determine building parameters programmed in a microprocessor, and used in existing buildings for one to several days. The extracted building parameters (i.e. UA, thermal mass) will provide a scoring which will be compared with standards for energy-efficient buildings to determine how far the building deviates from these standards.

The measured thermal properties in the actual as-built building may be used to ensure construction was done with sufficient care. That is, comparison of the empirically determined UA value with an expected value can be used to ensure that construction was of sufficient quality—that is, that thermal installation was installed in appropriate amounts and with sufficient care and that weatherstripping and air-tightness were adequate to obtain the intended thermal properties. This may be used as a basis to determine whether payment should be made for the work performed. The algorithms to determine the UA value are described elsewhere in this application.

In a similar vein, projected (simulated) energy performance may be a critical parameter to obtain a green building rating (e.g. LEED Platinum, Green Globes, various projected carbon footprints). The empirically determined thermal properties (e.g. UA, thermal mass or capacitance, and solar radiation response factor) may become the basis for establishing that the actual performance is sufficient to receive the intended green building rating, and may be used to confirm or validate the simulation associated with the green building rating. The building variables estimated with the proposed method can be used to precisely determine the energy efficiency of the building, projected energy consumption, and carbon footprint, which are key considerations in existing Green Building Rating systems. Similarly, energy simulations such as those performed using the software programs such as Energy Plus and Energy-10 may be improved using the empirically determined thermal properties in place of estimated values. The distinction is that empirically determined values reflect the true complexity of the building and actual workmanship, whereas estimated values are based on simplified, idealized abstractions that neglect complex three-dimensional geometry, penetrations for various utilities, wires, pipes, and potential defects in materials and workmanship.

1. A method for real-time monitoring of an energy characteristic of a building, the method comprising:
during nighttime steady-state conditions, recording nighttime steady-state thermal load data of the building and recording steady-state indoor and outdoor temperature data of the building;
computing a heat transfer coefficient of the building from the nighttime steady-state thermal load data and from the steady-state indoor and outdoor temperature data;
during nighttime transient conditions, recording transient indoor temperature data of the building and nighttime transient thermal load data of the building;
computing a thermal inertia of the building from the transient indoor temperature data and the nighttime transient thermal load data of the building;
during daytime, recording daytime thermal load data of the building, daytime indoor and outdoor temperature data of the building, and incident solar radiation data;
computing a solar radiation gain coefficient from the daytime thermal load data, the daytime indoor and outdoor temperature data, the incident solar radiation data, and the computed heat transfer coefficient;
estimating in real-time the energy characteristic of the building from the heat transfer coefficient, the thermal inertia, and the solar radiation gain coefficient, wherein the energy characteristic comprises (a) an energy performance of the building, or (b) a carbon offset of the building, or both (a) and (b).

2. The method of claim 1 wherein the thermal inertia of the building is computed from the heat transfer coefficient of the building.

3. The method of claim 1 wherein recording steady-state indoor and outdoor temperature data of the building during nighttime comprises collecting outdoor temperature data from a remote weather station.

4. The method of claim 1 wherein recording incident solar radiation data during daytime comprises collecting solar radiation data from a remote weather station.

5. The method of claim 1 further comprising estimating a building heating load from the steady-state indoor and outdoor temperature data of the building recorded during nighttime.

6. The method of claim 1 further comprising estimating a daytime thermal load of the building from the daytime indoor and outdoor temperature data of the building and the incident solar radiation data.

7. The method of claim 1 wherein estimating in real-time the energy characteristic of the building comprises estimating a carbon offset of the building by comparing performance of the building computed from measurements with a performance of otherwise similar buildings in conformance with building standards.

8. A method for determining thermal characteristics of a building, the method comprising:
during nighttime steady-state conditions, recording nighttime steady-state thermal load data of the building and recording steady-state indoor and outdoor temperature data of the building;
computing a heat transfer coefficient of the building from the nighttime steady-state thermal load data and from the steady-state indoor and outdoor temperature data;
determining from the heat transfer coefficient the thermal characteristics of the building, wherein the thermal characteristics comprise (a) a building energy score, (b) a building heating requirement, (c) a building energy retrofit estimate, (d) a building quality assurance value, or any combination of (a), (b), (c), and (d).

9. The method of claim 8 wherein determining the thermal characteristics of the building comprises determining a building heating requirement by estimating nighttime thermal loads using an overall heat transfer coefficient and measurements of real-time indoor/outdoor temperature differences.

10. The method of claim 8 wherein determining the thermal characteristics of the building comprises determining a building cooling requirement by using an overall heat transfer coefficient and measurements of real time indoor/outdoor temperature differences, and measurements of incident solar radiation.
